(19) United States
(12) Patent Application Publication
(10) Pub. No.: US 2022/0055842 A1
(43) Pub. Date: Feb. 24, 2022

(54) LINEAR MOTOR SYSTEM AND OPERATING METHOD FOR THE SAME

(71) Applicant: Schneider Electric Industries SAS, Rueil-Malmaison (FR)

(72) Inventor: Juergen NICKEL, Waldbuettelbrunn (DE)

(73) Assignee: Schneider Electric Industries SAS, Rueil-Malmaison (FR)

(21) Appl. No.: 17/445,519

(22) Filed: Aug. 20, 2021

(30) Foreign Application Priority Data
Aug. 21, 2020 (EP) 20305943.1

(51) Int. Cl. B65G 23/23; H02K 41/03

(52) U.S. Cl. CPC B65G 23/23; H02K 41/03

(57) ABSTRACT

The invention relates to a linear motor system, in particular a transport system, e.g. a multi-carrier, comprising: a guide track having a plurality of electromagnets arranged distributed along the guide track; at least one carrier that is guided by and movable along the guide track and that comprises a drive magnet for cooperating with the electromagnets of the guide track to move the carrier; and a control device for controlling the movement of the carrier relative to the guide track by a corresponding control of the electromagnets, wherein the control device is configured to control the carrier to perform a shaking movement.

The present invention relates to a linear motor system, in particular a transport system, e.g. a multi-carrier, comprising: a guide track having a plurality of electromagnets arranged distributed along the guide track; at least one carrier that is guided by and movable along the guide track and that comprises a drive magnet for cooperating with the electromagnets of the guide track to move the carrier; and a control device for controlling the movement of the carrier relative to the guide track by a corresponding control of the electromagnets. The invention also relates to a method of operating such a system.

Linear motors are widely used today. They can, for example, be used to move products in industrial plants, in particular to transport them. Multi-carriers are particularly advantageous for the flexible transport of the most varied products. They in particular comprise a plurality of carriers, that is transport units, that can be moved individually and independently of one another. In a typical multi-carrier system, the guide track is closed in itself, i.e. it is practically endless, which enables a revolving operation.

For example, it is frequently necessary in industrial plants to jog a product or a product quantity, for example for the purpose of compressing a bulk material or for the purpose of shaking a liquid. This typically takes place via a vibratory plate. Such a plate usually generates mechanical oscillations via an electric motor, in particular an AC motor, that drives a shaft subject to an imbalance. It is disadvantageous here that a complex additional mechanical system, which is cost-intensive not only in the provision, but also in the maintenance, has to be provided by the vibratory plate. In addition, the vibratory plate often forms a fixed and independent station in a plant, which means that the respective product has to be specifically conveyed to and transferred to the vibratory plate. Furthermore, the movement profile of the shaking movement, its frequency and/or its amplitude are often constant or, for example, only manually adaptable.

It is an object of the invention to jog a product, which is e.g. moved in an industrial plant, in a particularly simple manner.

This object is satisfied by a linear motor system in accordance with claim 1, and in particular in that the control device is configured to control the carrier to perform a shaking movement.

The linear motor system is therefore used in an advantageous manner to perform a shaking movement for which purpose separate devices, for example vibratory plates, were typically provided in the prior art. In this respect, the generally anyway present ability of the control device to drive the carrier to perform a movement is used to perform a shaking movement. No additional device is therefore required for the shaking. On the contrary, in a linear motor system of the initially mentioned kind, the invention can generally be realized without any additional hardware, namely in particular only by a corresponding implementation in the software of the control device. Since the shaking function is generally not spatially bound—i.e. such that shaking cannot only take place at a specific location as is the case at a separate shaking station —, a plant that comprises the linear motor system can be designed much more compactly overall. Furthermore, the plant is particularly flexible. The shaking function is also not time-bound, but can be performed at any desired locations and points in time during the process, for example.

The shaking movement is generally a movement with a repeated acceleration change in the guidance direction, i.e. in the “normal” direction of movement of the carrier. When the carrier is stationary apart from the shaking movement, the shaking movement is expressed as a back-and-forth movement along the guide track. In this respect, the movement path is small. The shaking movement is therefore a micro-movement, with this being in contrast to a “normal” movement along the guide track that is designated as a macro-movement herein. The term micro-movement is naturally not limited to a movement in the micrometer range, but simply refers to the fact that the movement is small in comparison with the normal movement or macro-movement. The macro-movement can, for example, be a movement between two stations of an industrial plant. The macro-movement can in particular be a transport movement, that is a movement for the purpose of transporting a product from one location to the next.

It is generally also possible to combine the shaking movement with a “normal” movement, that is to perform the shaking movement during a “normal” movement or a macro-movement. In this case, the shaking movement is expressed in a repeated speed increase and decrease. The shaking movement can, for instance, be generated by a repeated, in each case brief, acceleration and subsequent deceleration of the carrier. The shaking movement during a macro-movement can also be considered as a back-and-forth movement in the inertial system of the carrier that is moved in accordance with the macro-movement.

In connection with liquids, one also speaks of “shaking” (German: Schütteln) instead of “shaking” (German: Rütteln). Thus, the term “shaking (Rütteln) movement” also includes the meaning “shaking (Schütteln) movement”, in particular for the case that a liquid is moved by the carrier.

In accordance with an advantageous embodiment, provision is made that the shaking movement is a vibration. A vibration of the carrier can, for example, be advantageously used to assist a discharge of a powdery product from the carrier.

The shaking movement can preferably have a frequency of at least 10 Hz, further preferably at least 25 Hz, further preferably at least 50 Hz. Alternatively or additionally, the frequency can preferably amount to at most 200 Hz, further preferably at most 150 Hz.

Alternatively or additionally, the shaking movement can preferably have an amplitude of at least 0.5 mm, further preferably at least 1 mm. The amplitude can preferably amount to at most 5 mm, further preferably at most 3 mm. The amplitude is generally half the total distance between two deflection maxima, that is it refers to a zero point around which the shaking takes place.

The shaking movement can e.g. comprise at least one acceleration of the carrier and/or of a product of 1 G, preferably 3G, arranged at the carrier in the direction of movement of the carrier.

Advantageous examples comprise the shaking movement having a movement profile, in particular with respect to a position and/or a speed, that is at least substantially wave-like, e.g. sinusoidal, or triangular.

It is particularly advantageous if the shaking movement is settable and/or changeable, in particular with respect to a frequency, an amplitude, and/or a movement profile of the shaking movement. This allows a particularly flexible use of the linear motor system in different processes and in particular for shaking different products. Thus, the shaking movement can, for instance, be set differently for different products, in particular different bulk materials, such as rice, pasta, sugar, flour, or even smaller assembly parts, and/or different liquids. In the case of a plurality of carriers, the shaking movement is individually settable and/or changeable, in particular for each carrier.

Embodiments in which the shaking movement is variable in time are particularly advantageous. In principle, the shaking movement can, for example, be settable and/or changeable in dependence on conditions, and in particular for each carrier individually in the case of a plurality of carriers. For example, a time lapse, a position of the carrier relative to the guide track, and/or a state of a product moved by the carrier can be considered as a condition. A change in time of the shaking movement can, for example, be realized by a predefined and/or predefinable frequency curve and/or amplitude curve, for example in dependence on the time and/or a position. A product can e.g. behave differently in dependence on states such that it can be further processed more quickly in the process by an optimized shaking method. This, for example, applies in the case of products that are poured out to make them free of bubbles.

To illustrate further advantages of the approaches described above, an industrial application can, for example, be considered in which a bulk material, in particular a powder, is to be compressed by means of the shaking movement. In this respect, an ideal frequency and/or amplitude can, for example, be dependent on states, i.e. different frequencies and/or amplitudes can be ideal for different compression states. If the frequency and/or the amplitude is/are now adapted to the compression state, the compression process can be accelerated overall since essentially the ideal frequency or amplitude is always applied. In this respect, the actual compression state can, for example, be determined by sensors or derived from known time relationships. As a result, the process can be shortened in time and/or with respect to a transport route. A similar or better result can be achieved in a shorter time or over a shorter distance. What was stated above not only applies to frequency and amplitude, but generally to all the properties of the shaking movement, e.g. also to a movement profile of the shaking movement.

The shaking movement can, for example, be performed in a continuous, pulse-like, or pulsating manner. Any desired combinations thereof are also possible.

Ultimately, a shaking program of generally any desired complexity can be predefined as required.

In general, each carrier can be settable, in particular individually settable, in dependence on conditions, for example in dependence on time, position and/or states, in its shaking movement, in particular with respect to frequency, amplitude, and/or a movement profile of the shaking movement. It can hereby in particular be made possible that the same shaking quality, or shaking quality, or vibration quality is always achieved at different speeds of a longitudinal movement of the carrier at the guide track, that is during a macro-movement.

The shaking movement can, for example, also be recorded, for example for a specific product arranged at the carrier and/or for the period of time in which a specific product is arranged at the carrier. For sensitive products, e.g. in the pharmaceutical industry, it can, for example, be recorded how long they have been jogged or shaken in a filling or packaging process. This can, for example, also be advantageous on the mixing of a plurality of components, e.g. powders, liquids, etc.

Provision is made in an advantageous further development that the shaking movement can be performed during a longitudinal movement of the carrier along the guide track. The longitudinal movement can, for example, be a movement of the carrier that is anyway provided, for example, a transport movement. Due to the further development, the time required for this movement is advantageously used to also perform the shaking movement. Processes can hereby be shortened overall. Interruptions in the sequences can thus in particular be avoided and in particular no separate shaking stations are necessary. The longitudinal movement is generally a macro-movement, for example a movement from one station to the next. The shaking, that is a micro-movement, is performed during this macro-movement.

Alternatively or additionally, the shaking movement can also be performed when the carrier is at a standstill, i.e. without a macro-movement. This can, for example, be advantageous if a product is to be jogged while it is fed to the carrier, with the feeding taking place at a standstill. In general, the processes in connection with the stationary feed devices and/or discharge devices can therefore be optimized, for example.

Furthermore, the shaking movement can, for example, also be combined with a longitudinal movement in a curve section of the guide track to produce a revolving pivot movement at the product. In the curve, a centrifugal force acts on the product that can be absorbed by the shaking movement when exiting the curve such that a revolving pivot movement is produced and can also be maintained over a longer straight travel—driven by the one-dimensional shaking movement. This approach is therefore in particular suitable for pivoting a liquid moved by the carrier in a revolving manner, e.g. for the purpose of a particularly good mixing of components of the liquid.

In a further embodiment, provision is made that the shaking movement can be performed at different positions with respect to the guide track and/or in different sections of the guide track, in particular wherein a position and/or a section can be selected. The flexibility in the use of the linear motor system for shaking is hereby further improved. It is particularly advantageous if the shaking movement can be performed at any desired position with respect to the guide track and/or at any desired time.

With further advantage, the linear motor system can, for example, comprise a plurality of carriers, in particular carriers that can be moved independently of one another. The plurality or all of the carriers can preferably be controlled to perform a shaking movement, in particular independently of one another.

In principle, the control device can, for example, be configured to control at least two carriers to perform a synchronous longitudinal movement. It is hereby, for instance, possible to transport a product or a container with the at least two carriers. Larger products or containers can thus in particular also be transported.

In a further advantageous example, the linear motor system comprises at least two carriers, wherein the control device is configured to control the carriers to perform a synchronous shaking movement. This e.g. proves to be advantageous in the case that the at least two carriers carry and/or move a product together. The shaking movement is therefore in particular coordinated between the carriers such that the spacing between the carriers does not change. This can e.g. prove to be particularly advantageous in those applications in which a product is held between two carriers.

The carrier(s) can preferably be mechanically guided at the guide track, in particular by a roller guide.

Furthermore, the control device of a linear motor system of the initially mentioned kind is typically configured to regulate the movement of the carrier, in particular on the basis of feedback information such as position information. This allows a precise movement of the carrier along the guide track. For example, a speed regulation, a position regulation, an acceleration regulation, a current regulation, and/or a force regulation can be provided. Insofar as the control device is also configured to regulate the movement of the carrier, this regulation therefore generally relates to the longitudinal direction of the guide track. In relation thereto, for instance, the position, the speed, and/or the acceleration of the carrier, and/or the force exerted by the electromagnets on the carrier can be regulated.

In accordance with a further advantageous embodiment, the control device can comprise a movement regulation for the carrier, in particular a position and/or force regulation, wherein the shaking movement can be performed via the movement regulation. In this respect, a desired movement profile for the shaking movement can e.g. be transmitted as an input signal to the movement regulation. The movement profile can be generated in the control device, e.g. from predefined data, for example from a desired frequency, a desired amplitude, and/or a selection from predefined movement profile shapes. The control device can, for example, have a control library for generating a movement profile, for example a position development and/or force development, from predefined data. A control library is to be understood as a software library that is present or used in the control device and that provides functions for calculating a movement profile from the predefined data. Such a control library can generally not only be implemented in the control device of the linear motor system, but also, for example, in a process control system.

The object of the invention is also satisfied by a method in accordance with the independent claim directed thereto, namely by a method of operating a linear motor system, in particular a transport system, e.g. a multicarrier system, in particular a linear motor system of the kind described above, wherein the linear motor system comprises: a guide track having a plurality of electromagnets arranged distributed along the guide track; at least one carrier that is guided by and movable along the guide track and that comprises a drive magnet for cooperating with the electromagnets of the guide track to move the carrier; and a control device for controlling the movement of the carrier relative to the guide track by a corresponding control of the electromagnets, wherein the method comprises the carrier being controlled to perform a shaking movement.

During the method, a product or a product quantity can, for example, be arranged or become arranged at the carrier. The product can, for example, be disposed on the carrier or on a support connected to the carrier. The product can, for example, also be fastened to the carrier. For example, the product can also be suspended at the carrier. The product can also be arranged in a container that is arranged at the carrier. The same variety of possibilities of the arrangement at the carrier naturally apply to the container. The shaking movement can, for example, be performed while the product or the container is arranged at the carrier or also while the product or the container is fed to and/or discharged from the carrier.

The product can in particular be a bulk material and/or a liquid. For example, the product can comprise a powder, sand, small parts or the like. However, it is generally also possible to jog solid objects. In general, an object moved by the carrier can therefore, for example, be a product, a quantity or number of products, and/or a container or other carrier, e.g. for a quantity or number of products. A container can likewise have a variety of shapes, for example, it can be a bag, a box, a can, or a jar.

In accordance with an advantageous further development, provision is made that a product arranged at the carrier is manipulated by means of the shaking movement. Thus, the state of the product can be influenced in a simple manner. The product can, for example, be compressed, loosened, aligned, mixed, and/or degassed.

In a further embodiment, provision is made that the product is discharged from the carrier by means of the shaking movement. The discharge of the product can be supported in a simple manner by means of the shaking movement. The discharge can, for example, comprise emptying and/or cleaning a product container. For example, the discharge can also comprise a tipping out, wherein shaking then additionally takes place in an advantageous manner to accelerate the tipping out, to regulate the tipping out, and/or to achieve a more thorough tipping out.

In a further example, a plurality of products are arranged at the carrier, wherein the plurality of products are sorted by means of the shaking movement. Sorting processes can be supported in a simple manner by the shaking movement. A product can generally, for example, also be sieved with the support of the shaking movement.

A filling system, for instance for filling a bulk material or a liquid into a container, forms a further exemplary application of the method in accordance with the invention or of the linear motor system in accordance with the invention, for example. In this respect, the linear motor system can, for example, be used to position the container at a feed device and/or to transport the container. Due to the invention, the product or the container can be jogged in a simple manner here, in particular without the container having to be transferred to a separate shaking device, such as a vibratory plate, in the meantime.

It is understood that the methods described herein can also be further developed in the sense of the individual features and embodiments described with respect to the apparatus, that is in particular the linear motor system and the transport system, and vice versa.

The invention will be explained only by way of example in the following with reference to the schematic drawings.

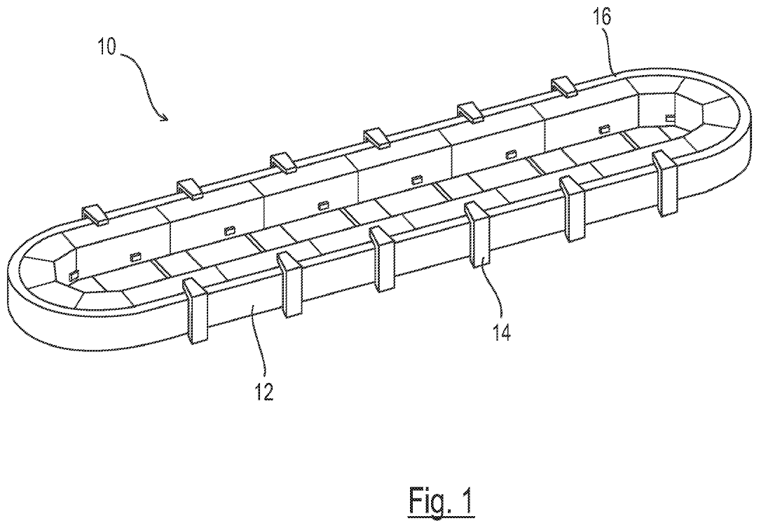

FIG. 1 shows a linear motor system configured as a transport system;

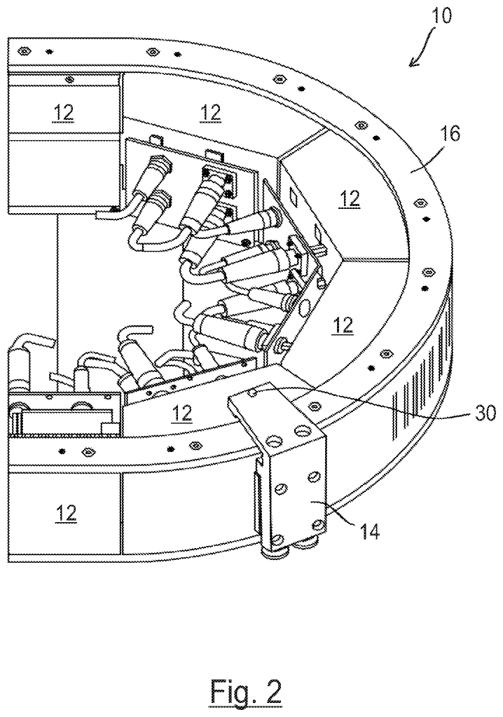

FIG. 2 shows a curve section of the transport system of FIG. 1;

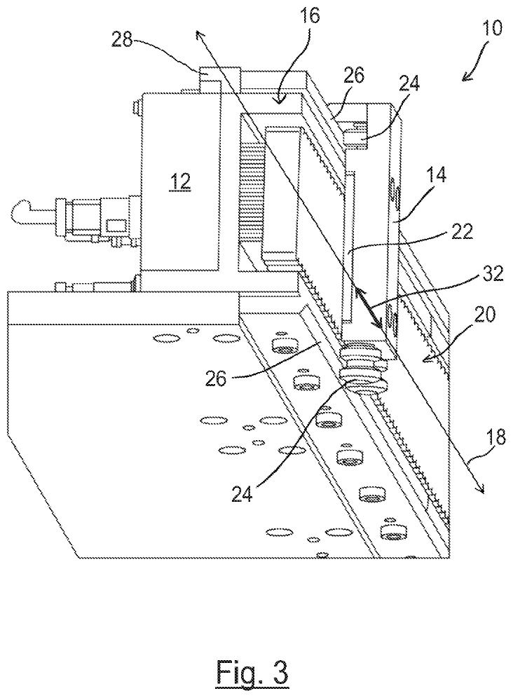

FIG. 3 shows a cross-section of the transport system of FIG. 1 with the sectional plane perpendicular to a guide track; and

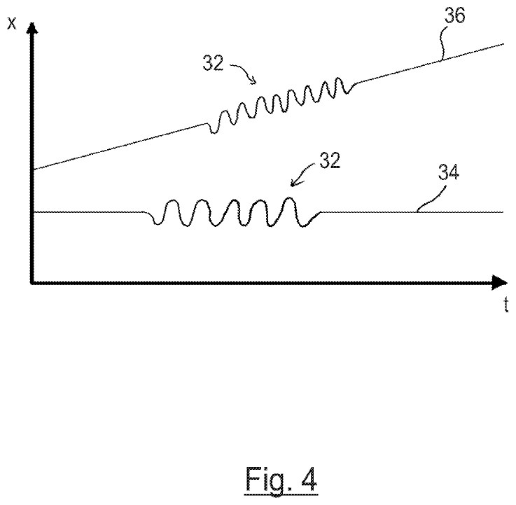

FIG. 4 shows a plotting of different movement paths with a shaking movement.

A transport system 10 in accordance with the invention, which is configured as a multi-carrier system, is shown in FIG. 1. The transport system 10 comprises a plurality of linear motors 12 that are arranged in rows such that a continuous and in this case revolving movement of the carriers 14 along a guide track 16 is made possible. The transport system 10 further comprises a plurality of carriers 14 that form individual transport elements of the transport system 10 and that can be moved along the guide track 16, in particular independently of one another, by means of the linear motors 12.

FIG. 2 shows a curve section of the transport system 10 in an enlarged view. Only one carrier 14 is shown here that is movable along the guide track 16, namely via the linear motors 12. Different electronic devices for controlling the linear motors 12 are visible at the side of the guide track 16 remote from the carrier 14, that is within the curve.

In FIG. 3, the transport system 10 is shown in a sectional view and enlarged. A carrier 14 is visible that is movably guided at the guide track 16. In this respect, the carrier 14 is movable along a guide axis 18 or a movement axis. For a movement along the guide axis 18, the carrier 14 is controlled by a plurality of electromagnets 20 that are arranged at the guide track 16 and that are uniformly distributed along it. The electromagnets 20 in this respect cooperate with a permanent magnet 22, which is arranged at the carrier 14 and which can also be designated as a drive magnet, for driving the carrier.

The carrier 14 is mechanically guided at the guide track 16, namely by a roller guide. Said roller guide comprises guide rollers 24 at the carrier 14 and guide rails 26 at the guide track 16. The carrier 14 is in this respect held at the guide track 16, in particular via the permanent magnet 22.

The transport system 10 furthermore comprises a position detection device 28. Said position detection device can, for example, be formed as a series of a plurality of magnetic sensors that extends along the guide track 16. For example, a permanent magnet 30, which can also be designated as a position magnet and is visible in FIG. 2, can be provided at the carrier 14.

The transport system 10 furthermore comprises a control device that is not shown separately and that is configured to control the electromagnets 20 in a targeted manner in order to move the carrier 14 along the guide track 16 or the guide axis 18. In this respect, the position detection device 28 returns position information relating to the position of the carrier 14 with respect to the guide axis 18 to the control device. The control device regulates the movement of the carrier 14 on the basis of the position information.

The control device is configured to control the carrier to perform a shaking movement 32 that is indicated by a double arrow in FIG. 3. When stationary, the shaking movement 32 is, for instance, formed as a relatively fast and small back-and-forth movement along the guide axis 18, for example with a frequency of at least 10 Hz and/or an amplitude of at most 5 mm. This can be achieved solely by a corresponding current application to the electromagnets 20 under the control of the control device. The linear motor system 10, within the framework of its largely typical design and with the components that are usually present anyway, is now used to additionally provide a shaking function. This function can, for example, only be realized by a corresponding software implementation and can also be retrofitted in a simple manner, for example. Due to the integrated shaking function, additional shaking devices can be omitted, on the one hand, and, on the other hand, a product arranged at the carrier 14 can be jogged flexibly and as required, for example at any desired location of the guide track, at any desired point in time, and/or with any desired form of the shaking movement 32, in particular with respect to the frequency, amplitude, and/or movement profile of the shaking movement 32. The shaking can furthermore take place both at standstill and during a longitudinal movement of the carrier 14. The shaking function of the control device can preferably be freely programmable. It is generally preferred that the parameters of the shaking movement 32, namely in particular the movement profile, frequency and/or amplitude, can also be settable and/or changeable during operation, in particular “on the fly”.

FIG. 4 shows a plotting of different movement paths of a carrier, wherein the abscissa represents the time and is designated as t, and wherein the ordinate represents the position of the carrier with respect to the guide track and is designated as x. The x direction thus corresponds to the guide axis 18 marked in FIG. 3.

A first movement path 34 illustrates the case that a shaking movement 32 takes place while the carrier is at a standstill with respect to its “normal” movement or macro-movement. The shaking movement 32 by way of example here has a wave-like, in particular sinusoidal, movement profile. During the shaking movement 32, the carrier is repeatedly deflected around an initial position. The amplitude in this respect in particular has at most a few millimeters. The carrier is completely stationary before and after the shaking movement 32 in time, i.e. it is stationary with respect to the macro-movement and is also not jogged. In FIG. 4, this is expressed by the horizontal sections of the movement path 34.

A second movement path 36 illustrates the case that a shaking movement 32 takes place while the carrier performs a macro-movement, for example, a movement between one station in the linear motor system to another station. The macro-movement is here formed by a movement with a constant speed. A shaking movement 32 is performed for a certain time section during the macro-movement, in particular without the speed of the macro-movement being changed. The shaking movement 32 here likewise has a wave-like movement profile that is in particular sinusoidal. However, the shaking movement 32 in this respect follows the moved desired position of the carrier and oscillates around it. The macro-movement takes place at a constant speed and without a shaking movement before and after the shaking movement 32 in time. In FIG. 4, this is expressed by the straight sections of the movement path 36 with a constant pitch.

### REFERENCE NUMERAL LIST

10 transport system
12 linear motor
14 carrier
16 guide track
18 guide axis
20 electromagnets
22 drive magnet
24 guide rollers
26 guide rail
28 position detection device
30 position magnet
32 shaking movement
34 movement path
36 movement path

1. A linear motor system (10), comprising:
a guide track (16) having a plurality of electromagnets (20) arranged distributed along the guide track;
at least one carrier (14) that is guided by and movable along the guide track (16) and that comprises a drive magnet (22) for cooperating with the electromagnets (20) of the guide track (16) to move the carrier (14); and
a control device for controlling the movement of the carrier (14) relative to the guide track (16) by a corresponding control of the electromagnets (20), characterized in that
the control device is configured to control the carrier (14) to perform a shaking movement (32).

2. A linear motor system (10) in accordance with claim 1,
wherein the shaking movement (32) is a vibration.

3. A linear motor system (10) in accordance with claim 1,
wherein the shaking movement (32) comprises a frequency of at least 10 and/or at most 200 Hz.

4. A linear motor system (10) in accordance with claim 1,
wherein the shaking movement (32) comprises an amplitude of at least 0.5 mm and/or at most 5 mm.

5. A linear motor system (10) in accordance with claim 1,
wherein the shaking movement (32) has a movement profile, in particular with respect to a position and/or a speed, that is at least substantially wave-like, e.g. sinusoidal, or triangular.

6. A linear motor system (10) in accordance with claim 5,
wherein the movement profile is with respect to a position and/or a speed.

7. A linear motor system (10) in accordance with claim 5,
wherein the movement profile is sinusoidal or triangular.

8. A linear motor system (10) in accordance with claim 1,
wherein the shaking movement (32) is settable and/or changeable and/or variable in time.

9. A linear motor system (10) in accordance with claim 8,
wherein the shaking movement (32) is settable and/or changeable in dependence on conditions.

10. A linear motor system (10) in accordance with claim 9,
wherein the conditions include at least one of the following: a frequency, an amplitude, a movement profile of the shaking movement (32).

11. A linear motor system (10) in accordance with claim 1,
wherein the shaking movement (32) can be performed during a longitudinal movement of the carrier (14) along the guide track (16).

12. A linear motor system (10) in accordance with claim 1,
wherein the shaking movement (32) can be performed at different positions with respect to the guide track (16) and/or in different sections of the guide track (16), in particular wherein a position and/or a section can be selected.

13. A linear motor system (10) in accordance with claim 12,
wherein a position and/or a section of the shaking movement (32) can be selected.

14. A linear motor system (10) in accordance with claim 1,
wherein the linear motor system (10) comprises a plurality of carriers (14) that can be controlled to perform a shaking movement (32) independently of one another.

15. A linear motor system (10) in accordance with claim 1,
wherein the linear motor system (10) comprises at least two carriers (14) and the control device is configured to control the carriers (14) to perform a synchronous shaking movement (32).

16. A linear motor system (10) in accordance with claim 1,
wherein the control device comprises a movement regulation for the carrier (14), and wherein the shaking movement (32) can be performed via the movement regulation.

17. A method of operating a linear motor system (10),
wherein the linear motor system (10) comprises:
a guide track (16) having a plurality of electromagnets (20) arranged distributed along the guide track (16);
at least one carrier (14) that is guided by and movable along the guide track (16) and that comprises a drive magnet (22) for cooperating with the electromagnets (20) of the guide track (16) to move the carrier (14); and
a control device for controlling the movement of the carrier (14) relative to the guide track (16) by a corresponding control of the electromagnets (20), wherein the method comprises
the carrier (14) being controlled to perform a shaking movement (32).

18. A method in accordance with claim 17,
wherein a product is arranged at the carrier (14), and
wherein the product is manipulated by means of the shaking movement (32) to be compressed, loosened, aligned, mixed, and/or degassed.

19. A method in accordance with claim 17,
wherein a product is arranged at the carrier (14), and
wherein the product is discharged from the carrier (14) by means of the shaking movement (32) and/or is fed to the carrier (14).

20. A method in accordance with claim 17,
wherein a plurality of products are arranged at the carrier (14), and
wherein the plurality of products are sorted by means of the shaking movement (32).
